(19) United States
(12) Patent Application Publication
(10) Pub. No.: US 2025/0330458 A1
(43) Pub. Date: Oct. 23, 2025

(54) METHODS AND SYSTEMS FOR CLIENT CERTIFICATE EXTRACTION IN DEVICE AUTHENTICATION

(71) Applicant: Nile Global, Inc., San Jose, CA (US)

(72) Inventors: Gopalakrishnan Raman, San Jose, CA (US); Suresh Katukam, Milpitas, CA (US); Dipen Vardhe, San Jose, CA (US)

(21) Appl. No.: 18/641,202

(22) Filed: Apr. 19, 2024

(51) Int. Cl. H04L 9/40

(52) U.S. Cl. CPC H04L 63/0823; H04L 63/0876; H04L 63/166

(57) ABSTRACT

Embodiments of a device and method are disclosed. In an embodiment, a method of communications involves at a network device, receiving an authentication message from a client, at the network device, extracting a payload from the authentication message, and sending a copy of the payload to a Transport Layer Security (TLS) microserver of the network device for client certificate extraction, where the TLS microserver is implemented in a side signal channel.

### BACKGROUND

Institute of Electrical and Electronics Engineers (IEEE) 802.1x protocol typically requires a client and a network to mutually authenticate each other before granting the client full access to the network. 802.1x authentication generally involves a client (or supplicant), which is the device that wishes to get access to a network, an Authentication Server (AS) (e.g., a Remote Authentication Dial-In User Service (RADIUS) server), which is an entity that is configured with information that allows it to validate the credentials presented by the client, and an authenticator, which is a network element that facilitates the exchange of 802.1x messages between the client and the AS. Typically, 802.1x messages between the client and the AS pass through the authenticator, which can implement security measures. However, implementing security measures in an authenticator can significantly increase the complexity of the authenticator and severely affect the performance of the authenticator.

### SUMMARY

Embodiments of a device and method are disclosed. Embodiments of a device and method are disclosed. In an embodiment, a method of communications involves at a network device, receiving an authentication message from a client, at the network device, extracting a payload from the authentication message, and sending a copy of the payload to a Transport Layer Security (TLS) microserver of the network device for client certificate extraction, where the TLS microserver is implemented in a side signal channel. Other embodiments are also described.

In an embodiment, the method further includes creating the TLS microserver on a per-client basis using a software package.

In an embodiment, the method further includes discarding an output that the TLS microserver produces.

In an embodiment, the method further includes storing extracted client certificate data and associated metadata in a file.

In an embodiment, the associated metadata includes a Medium Access Control (MAC) address of the client.

In an embodiment, the method further includes shutting down the TLS microserver as soon as a client certificate is extracted.

In an embodiment, the authentication message includes an Extensible Authentication Protocol (EAP) message.

In an embodiment, the method further includes at the network device, encapsulating the payload into an authentication request and from the network device, transmitting the authentication request to an authentication server.

In an embodiment, the authentication request includes a Remote Authentication Dial-In User Service (RADIUS) message.

In an embodiment, the method further includes at the network device, receiving an authentication response from the authentication server in response to the authentication request.

In an embodiment, the method further includes at the network device, generating an authentication response message based on the authentication response.

In an embodiment, the method further includes from the network device, transmitting the authentication response message to the client.

In an embodiment, the network device includes a head end (HE) deployed at a customer site.

In an embodiment, the authentication server is deployed remotely to the customer site.

In an embodiment, a device includes a transceiver configured to receive an authentication message from a client and one or more processors configured to extract a payload from the authentication message and send a copy of the payload to a TLS microserver of the device for client certificate extraction, where the TLS microserver is implemented in a side signal channel.

In an embodiment, the one or more processors are further configured to create the TLS microserver on a per-client basis using a software package.

In an embodiment, the one or more processors are further configured to discard an output that the TLS microserver produces.

In an embodiment, the one or more processors are further configured to store extracted client certificate data and associated metadata in a file.

In an embodiment, the associated metadata includes a MAC address of the client.

In an embodiment, a method of communications involves at a head end (HE) deployed at a customer site, receiving an authentication message from a wireless access point (AP) deployed at the customer site, at the HE, extracting a payload from the authentication message; sending a copy of the payload to a TLS microserver of the HE for client certificate extraction, where the TLS microserver is implemented in a side signal channel, storing extracted client certificate data and associated metadata in a file, at the HE, encapsulating the payload into an authentication request, and from the HE, transmitting the authentication request to an authentication server deployed remotely to the customer site.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a communications system in accordance to an embodiment of the invention.

FIG. 2 depicts an embodiment of a network device of the communications system depicted in FIG. 1.

FIG. 3 depicts an embodiment of a communications system in accordance to an embodiment of the invention.

FIG. 4 illustrates an example “side signal channel” processing operation of a head end (HE) of the communications system depicted in FIG. 3.

FIG. 5 shows a swim-lane diagram illustrating an example HE based authentication procedure.

FIG. 6 is a process flow diagram of a method of communications in accordance to an embodiment of the invention.

FIG. 7 is a process flow diagram of a method of communications in accordance to an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

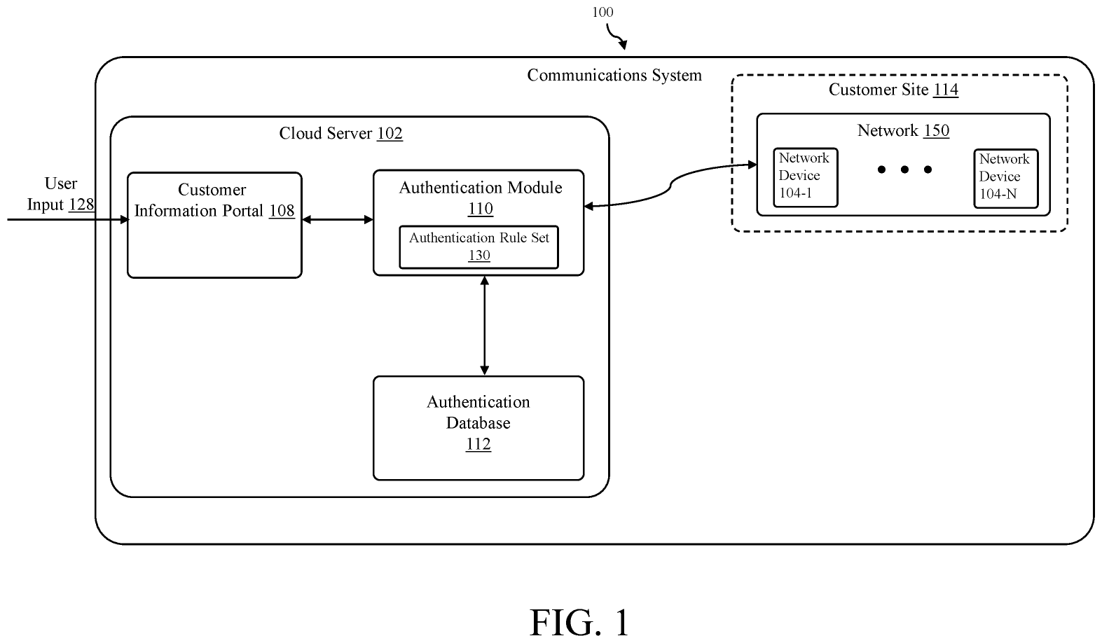

FIG. 1 depicts a communications system 100 in accordance to an embodiment of the invention. In the embodiment depicted in FIG. 1, the communications system includes a cloud server 102 and a deployed network 150 within a customer site 114. The cloud server and/or the network may be implemented in hardware (e.g., circuits), software, firmware, or a combination thereof. Although the illustrated communications system 100 is shown with certain components and described with certain functionality herein, other embodiments of the communications system may include fewer or more components to implement the same, less, or more functionality. For example, in some embodiments, the communications system includes more than one cloud server, more than one deployed network, and/or more than one customer site. In another example, although the cloud server and the deployed network are shown in FIG. 1 as being connected in certain topology, the network topology of the communications system 100 is not limited to the topology shown in FIG. 1.

The cloud server 102 can be used to provide at least one service to a customer site (e.g., to the deployed network 150 located at the customer site 114). The cloud server may be configured to facilitate or perform a security service (e.g., an authentication service) to network devices (e.g., the deployed network 150) at the customer site. Because the cloud server can facilitate or perform a security service to network devices at the customer site, network security can be improved. In addition, because the cloud server can facilitate or perform a security service to network devices at the customer site, a user or customer of the customer site can be notified of security issues. In some embodiments, the cloud server is configured to generate a user interface to obtain user input information regarding network security in a floor plan of a customer site. In some embodiments, the user interface includes a graphical user interface. The cloud server may be implemented in hardware (e.g., circuits), software, firmware, or a combination thereof. In some embodiments, the cloud server is implemented on a server grade hardware platform, such as an x86 architecture platform. For example, the hardware platform of the cloud server may include components of a computing device, such as one or more processors (e.g., CPUs), system memory, a network interface, storage system, and other Input/Output (I/O) devices such as, for example, a mouse and a keyboard (not shown). In some embodiments, the processor is configured to execute instructions such as, for example, executable instructions that may be used to perform one or more operations described herein and may be stored in the memory and the storage system. In some embodiments, the memory is volatile memory used for retrieving programs and processing data. The memory may include, for example, one or more random access memory (RAM) modules. In some embodiments, the network interface is configured to enable the cloud server to communicate with another device via a communication medium. The network interface may be one or more network adapters, also referred to as a Network Interface Card (NIC). In some embodiments, the cloud server includes local storage devices (e.g., one or more hard disks, flash memory modules, solid state disks and optical disks) and/or a storage interface that enables the host to communicate with one or more network data storage systems, which are used to store information, such as executable instructions, cryptographic keys, virtual disks, configurations, and other data.

In the embodiment depicted in FIG. 1, the cloud server 102 includes an authentication module 110, a customer information portal 108 connected to the authentication module 110, and an authentication database 112 configured to store authentication data. The authentication module, the customer information portal, and/or the authentication database may be implemented in hardware (e.g., circuits), software, firmware, or a combination thereof. In some embodiments, the cloud server 102 is a Remote Authentication Dial-In User Service (RADIUS) server. Although the illustrated cloud server is shown with certain components and described with certain functionality herein, other embodiments of the cloud server may include fewer or more components to implement the same, less, or more functionality. For example, in some embodiments, the cloud server includes more than one authentication module, more than one customer information portal, and/or more than one authentication database. In another example, although the authentication module, the customer information portal, and the authentication database are shown in FIG. 1 as being connected in certain topology, the network topology of the cloud server is not limited to the topology shown in FIG. 1. In addition, although the customer information portal 108 is shown in FIG. 1 as being a component of the cloud server 102, in other embodiments, the customer information portal may be implemented outside of the server. In some embodiments, the authentication module 110 is configured to facilitate or perform an authentication service to network devices (e.g., the deployed network 150) at the customer site 114, for example, using an authentication rule set 130. In some embodiments, the authentication rule set 130 may include one or more authentication rules for network devices at the customer site 114, for example, for performing an authentication service to network devices at the customer site 114. The authentication rule set 130 may include per-user credentials for the users of the network devices at the customer site 114, who wish to gain access to the network by proving their identity by demonstrating knowledge of configured credentials. In a strong form of authentication, the user device has a certificate (or public key) with a corresponding private key (known only to the user or to the device exclusively under the user's control). An example of a certificate is one defined by the X.509 standard. In some embodiments, the authentication database 112 is configured to store authentication data for a network deployed and/or to be deployed at the customer site (e.g., a list of network devices deployed or to be deployed at the customer site). Because the authentication module can facilitate or perform an authentication service to network devices at the customer site, network security can be improved. In addition, because the authentication module can facilitate or perform an authentication service to network devices at the customer site, a user or customer (e.g., a layperson such as a worker on-site or an end-user such as an employee) at the customer site can be notified of authentication issues. The customer information portal 108 is configured to receive customer input 128. In some embodiments, the customer information portal is configured to include or generate a user interface that allows a customer to input information associated with an authentication service for the customer site 114, such as one or more specific requirements or restrictions.

In the communications system 100 depicted in FIG. 1, the customer site 114 may include one or more buildings, and each building may include one or more floors. Network devices that can be deployed at the customer site may include any type of suitable network devices. For example, network devices may be designated to be deployed to a specific building, a specific floor within a building, and/or a specific location on a floor of a building. A network device that can be deployed at the customer site may be fully or partially implemented as an Integrated Circuit (IC) device. In the embodiment depicted in FIG. 1, the network 150 includes one or more network devices 104-1, . . . , 104-N, where N is a positive integer. In some embodiments, at least one of the one or more network devices 104-1, . . . , 104-N is a wired and/or wireless communications device that includes at least one processor (e.g., a microcontroller, a digital signal processor (DSP), and/or a central processing unit (CPU)), at least one wired or wireless communications transceiver implemented in one or more logical circuits and/or one or more analog circuits, at least one wired or wireless communications interface and that supports at least one wired or wireless communications protocol, and/or at least one antenna. For example, at least one of the one or more network devices 104-1, . . . , 104-N may be compatible with Institute of Electrical and Electronics Engineers (IEEE) 802.3 protocol and/or one or more wireless local area network (WLAN) communications protocols, such as IEEE 802.11 protocol. In some embodiments, at least one of the one or more network devices 104-1, . . . , 104-N is a wired communications device that is compatible with at least one wired local area network (LAN) communications protocol, such as a wired router (e.g., an Ethernet router), a wired switch, a wired hub, or a wired bridge device (e.g., an Ethernet bridge). In some embodiments, at least one of the one or more network devices 104-1, . . . , 104-N is a wireless access point (AP) that connects to a local area network (e.g., a LAN) and/or to a backbone network (e.g., the Internet) through a wired connection and that wirelessly connects to wireless stations (STAs), for example, through one or more WLAN communications protocols, such as an IEEE 802.11 protocol. In some embodiments, the network 150 includes at least one authentication server, at least one distribution switch (DS) or distribution layer switch that functions as a bridge between a core layer switch and an access layer switch, at least one head end (HE) or gateway, at least one access switch (AS) that can directly interact with a lower-level device (e.g., a wireless AP), at least one wireless AP, and/or at least one wireless sensor that wirelessly connects to a wireless AP. In some embodiments, at least one of the one or more network devices 104-1, . . . , 104-N is a wireless station (STA) that wirelessly connects to a wireless AP. For example, at least one of the one or more network devices 104-1, . . . , 104-N may be a wireless sensor, a laptop, a desktop personal computer (PC), a mobile phone, or other wireless device that supports at least one WLAN communications protocol (e.g., an IEEE 802.11 protocol).

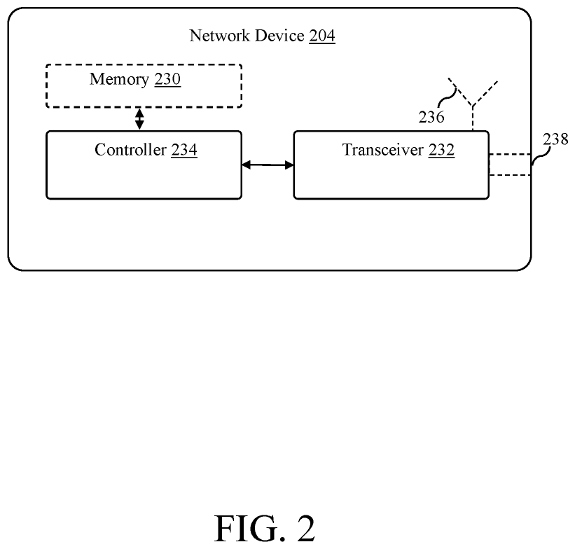

FIG. 2 depicts an embodiment of a network device 204 of the communications system depicted in FIG. 1. The network device 204 may be an embodiment of a network device that is included in the deployed network 150 depicted in FIG. 1. However, network devices that can be included in the deployed network 150 depicted in FIG. 1 are not limited to the embodiment depicted in FIG. 2. The network device 204 may be any suitable type of network device. For example, the network device 204 may be an authentication server, a head end (HE) or gateway, a wireless access point, or a sensor, described in details with reference to FIG. 2. In the embodiment depicted in FIG. 2, a network device 204 includes a wireless and/or wired transceiver 232, a controller 234 operably connected to the transceiver 232, at least one optional antenna 236 operably connected to the transceiver 232, and at least one optional network port 238 operably connected to the transceiver 232. In some embodiments, the transceiver 232 includes a physical layer (PHY) device. The transceiver 232 may be any suitable type of transceiver. For example, the transceiver 232 may be a short-range communications transceiver (e.g., a Bluetooth) or a WLAN transceiver (e.g., a transceiver compatible with an IEEE 802.11 protocol). In some embodiments, the network device 204 includes multiple transceivers, for example, a short-range communications transceiver (e.g., a Bluetooth) and a WLAN transceiver (e.g., a transceiver compatible with an IEEE 802.11 protocol). In some embodiments, the controller 234 is configured to control the transceiver 232 to process packets received through the antenna 236 and/or the network port 238 and/or to generate outgoing packets to be transmitted through the antenna 236 and/or the network port 238. In some embodiments, the controller 234 is configured to perform an authentication function for the network device 204. The antenna 236 may be any suitable type of antenna. For example, the antenna 236 may be an induction type antenna such as a loop antenna or any other suitable type of induction type antenna. However, the antenna 236 is not limited to an induction type antenna. The network port 238 may be any suitable type of port. For example, the network port 238 may be a local area network (LAN) network port such as an Ethernet port. However, the network port 238 is not limited to LAN network ports. In some embodiments, the network device 204 is a DS, a HE or gateway, an AS, a wireless AP, or a wireless sensor that wirelessly connects to a wireless AP. In some embodiments, the network device 204 includes memory 230, which may be a standalone unit or embedded into another component (e.g., the controller 234) of the network device 204. In some embodiments, the memory is volatile memory used for retrieving programs and processing data. The memory may include, for example, one or more random access memory (RAM) modules. Although the illustrated network device 204 is shown with certain components and described with certain functionality herein, other embodiments of the network device 204 may include fewer or more components to implement the same, less, or more functionality. In another example, although the components of the network device 204 are shown in FIG. 2 as being connected in certain topology, the network topology of the network device 204 is not limited to the topology shown in FIG. 2.

In some embodiments, the network device 204 operates as an authenticator according to an Institute of Electrical and Electronics Engineers (IEEE) 802.1x protocol, which is a network element that facilitates the exchange of 802.1x messages between a client that wishes to get access to a network and an Authentication Server (AS) (e.g., a Remote Authentication Dial-In User Service (RADIUS) server) that is configured to validate the credentials presented by the client, and an authenticator. Typically, 802.1x messages between the client and the AS pass through the authenticator, which can implement security measures. In some embodiments, the network device 204 transports the 802.1x messages between a client that participates in an 802.1x authentication protocol and an AS (e.g., a Radius server) and captures a credential (e.g., a certificate) presented by a client while the client participates in an 802.1x authentication protocol with an AS (e.g., a Radius server). By analyzing the extracted credentials (e.g., certificates), the network device 204 can alert an administrator about any impending credential (e.g., certificate) expiration. The network device 204 can also detect if more than one device is using the same credential (e.g., certificate) and help prevent credential theft thereby improving security.

In some embodiments, the network device 204 operates as an authenticator according to EAP-TLS (Extensible Authentication Protocol-Transport Layer Security). In EAP-TLS, a client and an AS (e.g., a Radius server) are provisioned with certificates. In some embodiments, each certificate has an associated public and private key. For example, the client certificate carries the public key of the client, and the server certificate has the public key of the AS. These certificates are typically signed by an authority that can be verified by both the client and the AS. For example, the TLS protocol (Request For Comments (RFC) 5246) defines a message exchange protocol that allows certificate based authentication between a client and a server. EAP defines a message format that allows TLS protocol messages to be encapsulated and transmitted between a client and an AS. In some embodiments, the network device 204 is an authenticator that is situated between a client and an AS and transports the EAP-TLS messages between the client and the AS. The authenticator can either be implemented in a wireless Access Point (AP) or a wired access switch to which the client is connected. In some embodiments, the authenticator is implemented in a centralized head-end (HE) that aggregates EAP-TLS messages from all the APs and switches in a network and is configured with credentials to communicate securely with an AS. Operating an authenticator on a HE may be advantageous because the HE can extract and analyze the EAP-TLS messages from all the clients in a network.

A conventional approach to obtain the client certificate at the HE involves at least, e.g., extracting TLS payloads from EAP messages, parsing the TLS payload and keeping track of a TLS protocol state machine per client, and identifying the specific messages that carry the client certificates, gathering the bytes that correspond to the certificate(s), and storing the certificate contents on non-volatile storage. However, such a approach may have drawbacks stemming from the complexity of implementing the TLS protocol state machine on a per-client basis. For example, the HE needs to understand the intricacies of various versions of the TLS protocol. In addition, TLS is a stream based protocol and TLS defines a record format to frame messages, which allows a TLS message to be spread across multiple packets and requires the HE to maintain state to implement a re-assembly. Message loss and re-transmissions add to the complexity of such operation. The HE needs to deal with multiple clients simultaneously, which involves state lookups and updates on a per-client basis. Further, the TLS protocol parsing can interfere with the main purpose of the authenticator, which is to function as a RADIUS client and interact with a RADIUS server. Errors at the authenticator can lead to a denial of service for the clients.

In some embodiments, the network device 204 operates as an authenticator according to EAP-TLS, which extracts client certificates without the need to interpret the TLS protocol messages. In addition to the normal function of the authenticator that extracts the EAP payload sent by a client and adds the EAP payload to the radius message, the network device 204 is configured to send a copy of the extracted EAP payload to a “side signal channel.” Within the network device 204, a TLS microserver is created on a per-client basis, which can be referred to as a MicroServer. In some embodiments, a TLS microserver is implemented as software (e.g., software codes or programs) executing on hardware (e.g., a processor). For example, programming languages provide a convenient software package (such as crypto/tlspackage in Golang) that implement a TLS microserver that utilizes few resources than a typical T:LS server. In some embodiments, a MicroServer is an instance of a TLS microserver running in its own thread or lightweight goroutine in the case of Golang. In some embodiments, the network device 204 obtains the copy of each message coming from the client off the “side signal channel”, and feeds the copy of each message to a TLS microserver instance that corresponds to the client's Medium Access Control (MAC) address. In some embodiments, the network device 204 discards any output that the TLS microserver instance produces, e.g., does not send the output to the client. In some embodiments, the network device 204 forwards any responses received from the actual RADIUS server to the client in a normal fashion. In some embodiments, a callback hook (also referred to as the MicroServer TLS state machine) is added to the TLS microserver after the TLS microserver extracts the client certificate(s) from the TLS protocol messages. Most programming languages provide this callback hook such that business logic can implement customized certificate validation criteria. In some embodiments, a callback hook or the MicroServer TLS state machine copies the certificate data into a disk file along with associated metadata, such as, the MAC address of the client and the username (if any) that is obtained from the EAP Identity Response message.

In some embodiments, the network device 204 includes the transceiver 232 configured to receive an authentication message from a client and one or more processors (e.g., the controller 234) configured to receive an authentication message from a client, extract a payload from the authentication message, and send a copy of the payload to a Transport Layer Security (TLS) microserver of the device for client certificate extraction, where the TLS microserver is implemented in a side signal channel. In some embodiments, the one or more processors are further configured to create the TLS microserver on a per-client basis using a software package. In some embodiments, the one or more processors are further configured to discard an output that the TLS microserver produces. In some embodiments, the one or more processors are further configured to store extracted client certificate data and associated metadata in a file. In some embodiments, the associated metadata includes a Medium Access Control (MAC) address of the client. In some embodiments, the one or more processors are further configured to shut down the TLS microserver as soon as a client certificate is extracted. In some embodiments, the authentication message includes an Extensible Authentication Protocol (EAP) message. In some embodiments, the one or more processors are further configured to encapsulate the payload into an authentication request and the transceiver 232 is configured to transmit the authentication request to an authentication server. In some embodiments, the authentication request includes a Remote Authentication Dial-In User Service (RADIUS) message. In some embodiments, the transceiver 232 is configured to receive an authentication response from the authentication server in response to the authentication request. In some embodiments, the one or more processors are further configured to generating an authentication response message based on the authentication response, for example, by extracting a payload from the authentication response and encapsulating the payload into the authentication response message. In some embodiments, the transceiver 232 is configured to transmit the authentication response message to the client. In some embodiments, the network device includes a head end (HE) deployed at a customer site. In some embodiments, the authentication server is deployed remotely to the customer site.

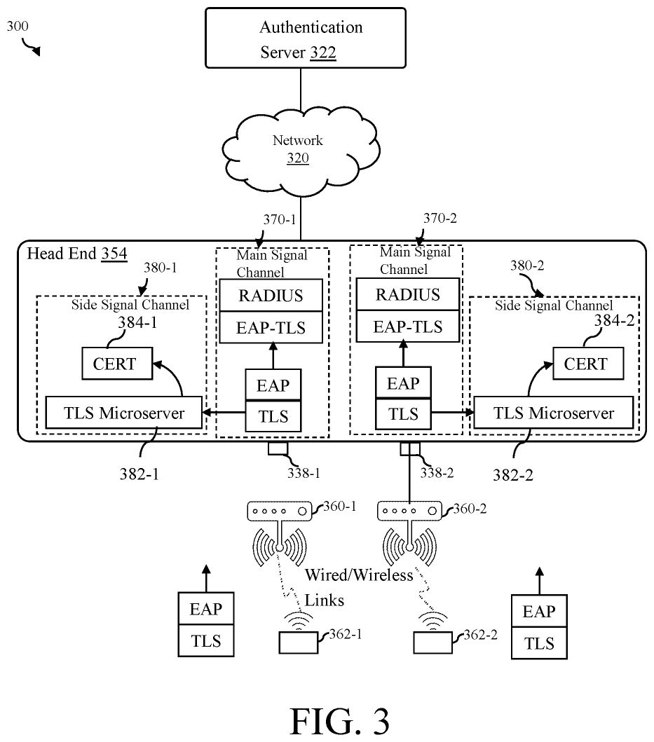

FIG. 3 depicts an embodiment of a communications system 300 in accordance to an embodiment of the invention. The communications system 300 depicted in FIG. 3 is one possible embodiment of the communications system 100 depicted in FIG. 1. However, the communications system 100 depicted in FIG. 1 is not limited to the embodiment shown in FIG. 3. In the embodiment depicted in FIG. 3, the communications system 300 includes an authentication server (e.g., a RADIUS server) 322, a network 320 (e.g., the Internet), a HE or gateway 354, two wireless APs 360-1, 360-2 connected to the HE 354, and two wireless clients 362-1, 362-2 that wirelessly connect to the wireless APs. The wireless clients may include a wireless sensor, a laptop, a desktop PC, a mobile phone, or other wireless device that supports at least one WLAN communications protocol (e.g., an IEEE 802.11 protocol). In some embodiments, instead of the wireless clients 362-1, 362-2 that wirelessly connect to the wireless APs, one or more wired clients are connected to the wireless APs through one or more cables or wires. In some embodiments, at least one of the authentication server 322, the HE 354, the wireless APs 360-1, 360-2, and the wireless clients 362-1, 362-2 depicted in FIG. 3 is implemented as the network device 204 depicted in FIG. 2. In some embodiments, the authentication server 322 is configured to facilitate or perform an authentication service to the wireless clients 362-1, 362-2, for example, using an authentication rule set, which may include one or more authentication rules. The authentication server 322 and/or the HE or gateway 354 may be located in the customer site 114 or remotely to the customer site 114 (e.g., in a remote data center). For example, the authentication server 322 may be implemented as the cloud server 102 depicted in FIG. 1. Although the illustrated communications system 300 is shown with certain components and described with certain functionality herein, other embodiments of the communications system 300 may include fewer or more components to implement the same, less, or more functionality. In another example, although the components of the communications system 300 are shown in FIG. 3 as being connected in certain topology, the network topology of the communications system 300 is not limited to the topology shown in FIG. 3.

In the embodiment depicted in FIG. 3, the authentication (e.g., RADIUS) protocol related parts of the IEEE 802.1x authenticator function are implemented in the HE 354 (e.g., in a controller of the HE 354). The HE 354 is used as a central entity that functions as a front end to the authentication server 322 (e.g., a RADIUS server) while retaining the IEEE 802.1x related authenticator functions in the corresponding wireless AP 360-1 or 360-2. In some embodiments, the authentication server 322 is a RADIUS server. In these embodiments, the HE serves as a RADIUS front end and relays messages between a RADIUS server (the authentication server 322) and a corresponding wireless AP. In some embodiments, the HE 354 signs authentication messages (e.g., RADIUS messages) using a shared secret, which can be shared, for example, between the HE 354 and the authentication server 322 (e.g., a RADIUS server). In some embodiments, cryptographic security is implemented between the wireless AP 360-1 or 360-2 and the HE 354 to protect IEEE 802.1x messages in the end-to-end path. In some embodiments, the HE 354 includes a transceiver (not shown), which may be a wireless and/or wired transceiver, a controller (not shown) operably connected to the transceiver and including or storing a client table, and a number of network ports 338-1, 338-2, which may be logical ports or physical ports, that can be operably connected to the transceiver. The network ports 338-1, 338-2 may be located outside, on, and/or inside the packaging of the HE 354. In some embodiments, the transceiver includes a PHY device. In some embodiments, the network ports 338-1, 338-2 are Transmission Control Protocol (TCP) connections where each TCP connection corresponds to a wireless AP. The transceiver may be any suitable type of transceiver. In some embodiments, the controller is configured to control the transceiver to process packets received through the network ports 338-1, 338-2 and/or to generate outgoing packets to be transmitted through the network ports 338-1, 338-2. In some embodiments, the controller is configured to perform an authentication function for the wireless clients 362-1, 362-2. The network ports may be any suitable type of port. For example, the network ports may be LAN network ports such as Ethernet ports. However, the network ports are not limited to LAN network ports. Although the illustrated HE 354 is shown with certain components and described with certain functionality herein, other embodiments of the HE may include fewer or more components to implement the same, less, or more functionality. For example, in some embodiments, the HE includes memory, which may be a standalone unit or embedded into another component (e.g., the controller) of the HE. In another example, although the components of the HE are shown in FIG. 3 as being connected in certain topology, the topology of the HE is not limited to the topology shown in FIG. 3.

In the embodiment depicted in FIG. 3, four different types of entities, which are the wireless clients 362-1, 362-2, the wireless APs 360-1, 360-2, the HE 354, and the authentication server 322 participate in IEEE 802.1x authentication. The wireless clients 362-1, 362-2 (e.g., Wi-Fi clients) are the entities that need to be authenticated before being allowed to access the network. In the embodiment depicted in FIG. 3, the wireless clients 362-1, 362-2 associate with the wireless APs 360-1, 360-2, respectively. Each wireless AP sends authentication messages received from one or more of the wireless clients 362-1, 362-2 over a specific connection to the HE 354. For example, the wireless AP 360-2 sends authentication messages from the wireless client 362-1 to the HE 354, while the wireless AP 360-2 sends one or more authentication messages from the wireless client 362-2 to the HE. Any authentication responses to a client are also received by a corresponding wireless AP. For example, the wireless AP 360-1 receives authentication responses to the wireless client 362-1 and transmits response data to the wireless client 362-1, while the wireless AP 360-2 receives authentication responses to the wireless client 362-2 and transmits response data to the wireless client 362-2. The HE 354 acts as a front end to the authentication server 322, which may be a RADIUS server. In some embodiments, the HE 354 maintains a client table, which can contain client data, e.g., a row for each client. In some embodiments, the HE 354 is configured to transmit at least one authentication request and to receive at least one authentication response.

In an example operation of the communications system 300 depicted in FIG. 3, the HE 354 operates as an authenticator according to EAP-TLS in main signal channels (referred to as main signal channels 370-1, 370-2) that extract client certificates without the need to interpret the TLS protocol messages. In addition to the normal function of the authenticator that extracts the EAP payload sent by a client and adds the EAP payload to a radius message in the main signal channels 370-1, 370-2, the HE 354 sends a copy of the extracted EAP payload to a side signal channel 380-1 or 380-2. In each side signal channel, a TLS server 382-1 or 382-2 is created on a per-client basis, which can be referred to as a TLS MicroServer. In some embodiments, a TLS microserver is implemented as software (e.g., software codes or programs) executing on hardware (e.g., a processor). For example, programming languages provide a convenient software package (such as crypto/tlspackage in Golang) that implement a TLS microserver that utilizes few resources than a typical T:LS server. In some embodiments, a MicroServer is an instance of a TLS server running in its own thread or lightweight goroutine in the case of Golang. In some embodiments, the HE 354 obtains the copy of each message coming from the client 362-1 or 362-2 off the “side signal channel” 380-1 or 380-2, and feeds the copy of each message to the TLS microserver instance 382-1 or 382-2 that corresponds to the client's MAC address. In some embodiments, the HE 354 discards any output that the TLS microserver instance 382-1 or 382-2 produces, e.g., do not send the output to the client 362-1 or 362-2, while forwards any responses received from the AS 322 (e.g., an actual RADIUS server) to the client 362-1 or 362-2. In some embodiments, a callback hook (also referred to as the MicroServer TLS state machine) is added to the TLS microserver 382-1 or 382-2 after the TLS microserver 382-1 or 382-2 extracts the client certificate(s) 384-1 or 384-2, respectively, from the TLS protocol messages. Most programming languages provide this callback hook such that business logic can implement customized certificate validation criteria. In some embodiments, a callback hook or the MicroServer TLS state machine copies the certificate data into a disk file along with associated metadata, such as, the MAC address of the client and the username (if any) that is obtained from the EAP Identity Response message. The main authenticator code path is not even aware of the TLS microservers 382-1, 382-2 in the side signal channels 380-1, 380-2. All the TLS specific work is done by the MicroServers 382-1, 382-2 in the side signal channels 380-1, 380-2. In some embodiments, the MicroServer 382-1 or 382-2 is shut down and its resources are freed up as soon as the certificate 384-1 or 384-2 is extracted.

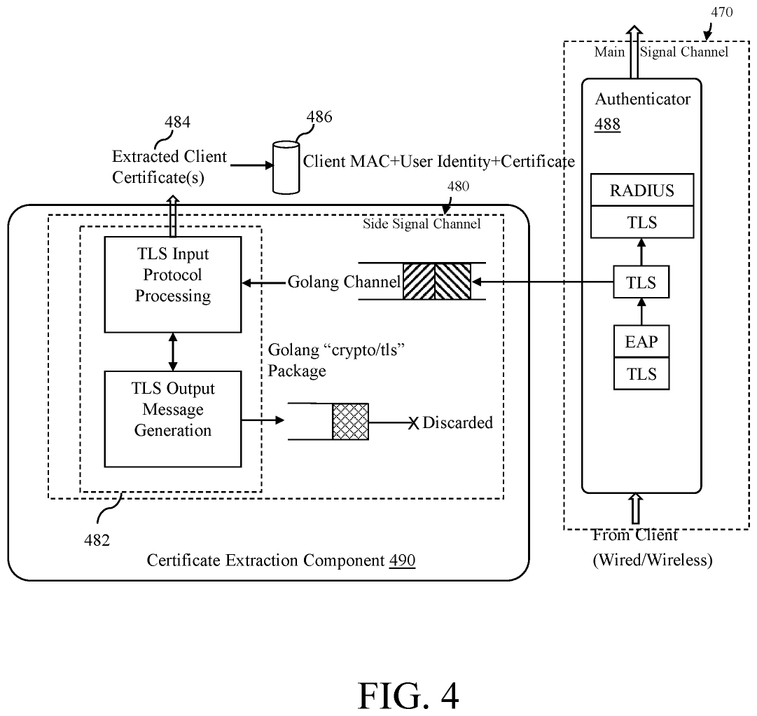

FIG. 4 illustrates an example “side signal channel” processing operation of the HE 354 of the communications system 300 depicted in FIG. 3. As illustrated in FIG. 4, a side signal channel 480, which can be, for example, a Golang channel, is used to send a copy of the TLS payload to a TLS microserver 482, which can run as a go-routine. The TLS microserver 482 may also be a separate thread or a different processor in the server/HE. The only additional operation on the main signal channel (referred to as the main signal channel) 470 is to post a copy of the extracted TLS payload to the Golang channel. Any output from the local TLS microserver is discarded. Extracted certificates 484 are saved to non-volatile storage 486 or streamed to the cloud. The client MAC address and user identity are also saved with the certificate. In some embodiments, the TLS microserver 482 and the side signal channel 480 are included in a certificate extraction component 490, which may be implemented as software (e.g., software codes or programs) executing on hardware (e.g., a processor).

In some embodiments, the software component on the HE that facilitates the transport of EAP-TLS data is called the “Authenticator” 488, which is a software program or process that runs on the CPU of the HE in the main signal channel 470. The authenticator receives EAP-TLS messages from one or (or more) Access Points (APs) and Access Switches (ASs). These EAP-TLS messages originate from wireless or wired clients connected to these APs or ASs. To enable certificate extraction, the authenticator delivers a copy of the EAP payload to the TLS microserver 482 in addition to forwarding the EAP payload to the primary authentication server.

There are various ways to deploy the TLS microserver 482. In some embodiments, an instance of the Golang package crypto/tls can operate in server mode. The main path delivers the TLS data to the secondary server by sending the TLS data on a Golang channel. If there are a large number of clients, running a large number of TLS microserver instances within the authenticator may lead to performance issues. In this case, the authenticator can send the TLS payload data over a different communication channel to an external program/process. The external process can either be co-located on the HE, running on a different computer in the LAN, or may even be a cloud instance. Running the external process in the cloud has benefits such as the ability to spin up more instances as the load increases. In some embodiments, hybrid approaches are used in which the load is processed locally until the load reaches a certain threshold and after that TLS data can be offloaded to the cloud or to a local server farm.

In some embodiments, the client certificates 484 are captured and stored with metadata over a long period of time, which can be used for data analytics and to train artificial intelligence (AI) models.

In some embodiments, the TLS microserver 482 can be used for client fingerprinting and anomaly detection. It can be used to detect certain kinds of attacks where hackers steal credentials of authorized users.

In some embodiments, the TLS microserver 482 can be used for enforcing access policies, such as, (1) time based access, (2) geographical (geo) based access, (3) putting clients that match a certain criteria into a “quarantine” subnet to allow them to be rectified and limit the damage that they can do.

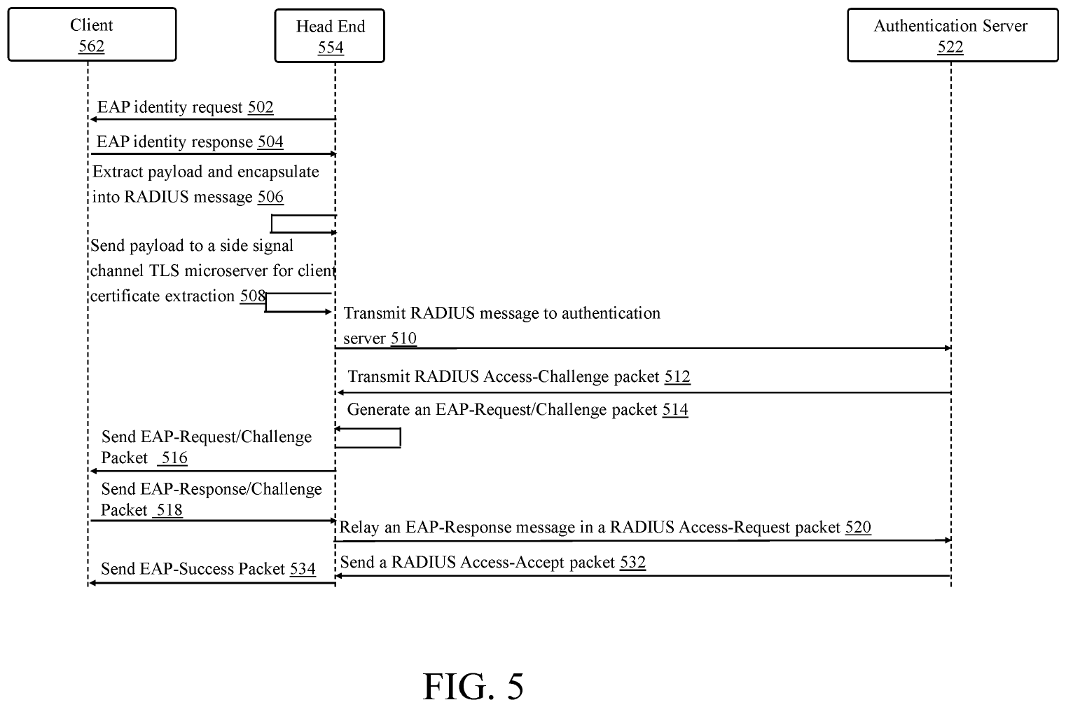

FIG. 5 shows a swim-lane diagram illustrating an example head end based authentication procedure between a wireless or wired client 562, a HE 554, and an authentication server 522 (e.g., a RADIUS server). In the authentication procedure depicted in FIG. 5, the HE 554 functions as a front end to the authentication server 522 (e.g., a RADIUS server). The client 562 depicted in FIG. 5 may be a wired client or a wireless client. In some embodiments, the client 562 depicted in FIG. 5 is similar to, the same as, or a component of the clients 362-1, 362-2 depicted in FIG. 3. The HE 554 depicted in FIG. 5 may be similar to, the same as, or a component of the HE 354 depicted in FIG. 3. The authentication server 522 depicted in FIG. 5 may be similar to, the same as, or a component of the authentication server 322 depicted in FIG. 3. Although operations in the example procedure in FIG. 5 are described in a particular order, in some embodiments, the order of the operations in the example procedure may be altered so that certain operations may be performed in an inverse order or so that certain operations may be performed, at least in part, concurrently with other operations.

In the swim-lane diagram depicted in FIG. 5, the HE 554 starts an authentication process (e.g., the EAP authentication process) by sending an EAP identity request packet to ask for a client username in operation 502 and receives an EAP identity response from the client 562 with the username in operation 504. In operation 506, the HE 554 extracts a payload from the received EAP identity response and encapsulates the payload into a RADIUS message. In operation 508, the HE 554 sends the payload to a side signal channel TLS microserver for client certificate extraction. In operation 510, the HE 554 then relays the EAP-Response/Identity packet in a RADIUS Access-Request packet to the authentication server 522. In operation 512, the authentication server 522, which acts as a RADIUS server, sends/transmits a RADIUS access challenge packet. For example, the authentication server 522, which acts as a RADIUS server, uses the identity information in the RADIUS Access-Request to search its user database. If a matching entry is found, the authentication server 522 generates an EAP message that initiates either a per-user configured EAP method such as EAP-TLS or a default EAP method if none is configured. In some embodiments, the authentication server 522 encapsulates the EAP message as 1 or more attributes of a RADIUS Access-Challenge packet and sends it to the HE 554 to be eventually delivered to the wired/wireless client device (e.g., via an access point or access switch). In operation 514, the HE 554 generates an EAP-Request/Challenge packet, e.g., by extracting an EAP payload from the RADIUS Access-Challenge packet and encapsulating the EAP payload into the EAP-Request/Challenge packet. In operation 516, an EAP-Request/Challenge packet is sent from the HE 554 to the client 562. For example, the client uses the received challenge to encrypt the password, and sends the encrypted password in an EAP-Response/Challenge packet to the HE in operation 518. The HE 554 may extract an EAP-Response message and encapsulate it into a RADIUS Access-Request packet. In addition, the HE 554 may send the RADIUS Access-Request packet or its payload to a side signal channel TLS microserver for client certificate extraction. In operation 520, the HE relays the EAP-Response message in the RADIUS Access-Request packet to the authentication server 522. The authentication server continues with the EAP protocol processing and several Access-Challenge and corresponding Access-Request Radius messages are exchanged between the AS and the HE. Finally, if the EAP method succeeds, the authentication server sends/transmits a RADIUS Access-Accept packet to the HE in operation 532. In operation 534, upon receiving the RADIUS Access-Accept packet, the HE 554 sends an EAP-Success packet to the client such that the client can access the network.

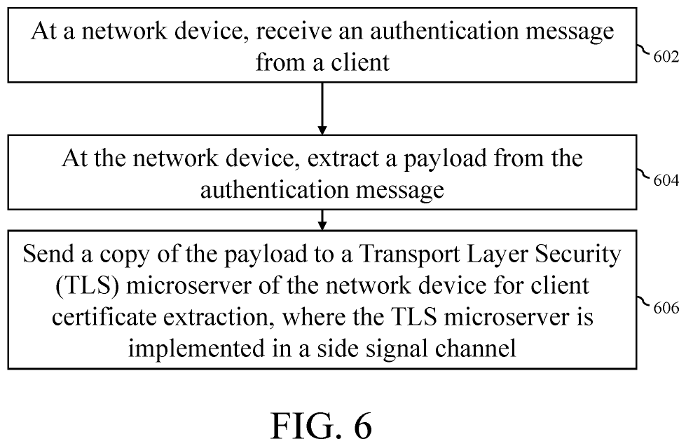

FIG. 6 is a process flow diagram of a method of communications in accordance to an embodiment of the invention. According to the method, at block 602, at a network device, an authentication message is received from a client. At block 604, at the network device, a payload is extracted from the authentication message. At block 606, a copy of the payload is sent to a Transport Layer Security (TLS) microserver of the network device for client certificate extraction, where the TLS microserver is implemented in a side signal channel. In some embodiments, the TLS microserver is created on a per-client basis using a software package. In some embodiments, an output that the TLS microserver produces is discarded. In some embodiments, extracted client certificate data and associated metadata is stored in a file. In some embodiments, the associated metadata includes a Medium Access Control (MAC) address of the client. In some embodiments, the TLS microserver is shut down as soon as a client certificate is extracted. In some embodiments, the authentication message includes an Extensible Authentication Protocol (EAP) message. In some embodiments, at the network device, the payload is encapsulated into an authentication request, and from the network device, the authentication request is transmitted to an authentication server. In some embodiments, the authentication request includes a Remote Authentication Dial-In User Service (RADIUS) message. In some embodiments, at the network device, an authentication response is received from the authentication server in response to the authentication request. In some embodiments, at the network device, an authentication response message is generated based on the authentication response, for example, a payload is extracted from the authentication response, and at the network device, the payload is encapsulated into the authentication response message. In some embodiments, from the network device, the authentication response message is transmitted to the client. In some embodiments, the network device includes a head end (HE) deployed at a customer site. In some embodiments, the authentication server is deployed remotely to the customer site. The network device may be similar to, the same as, or a component of the network devices 104-1, . . . , 104-N depicted in FIG. 1, the network device 204 depicted in FIG. 2, the HE 354 depicted in FIG. 3 and/or the HE 554 depicted in FIG. 5. The client may be similar to, the same as, or a component of the network devices 104-1, . . . , 104-N depicted in FIG. 1, the network device 204 depicted in FIG. 2, the wireless APs 360-1, 360-2 depicted in FIG. 3, the wireless clients 362-1, 362-2 depicted in FIG. 3 and/or the client 562 depicted in FIG. 5. The authentication server may be similar to, the same as, or a component of the authentication server 322 depicted in FIG. 3 and/or the authentication server 522 depicted in FIG. 5. The customer site may be similar to, the same as, or a component of the customer site 114 depicted in FIG. 1.

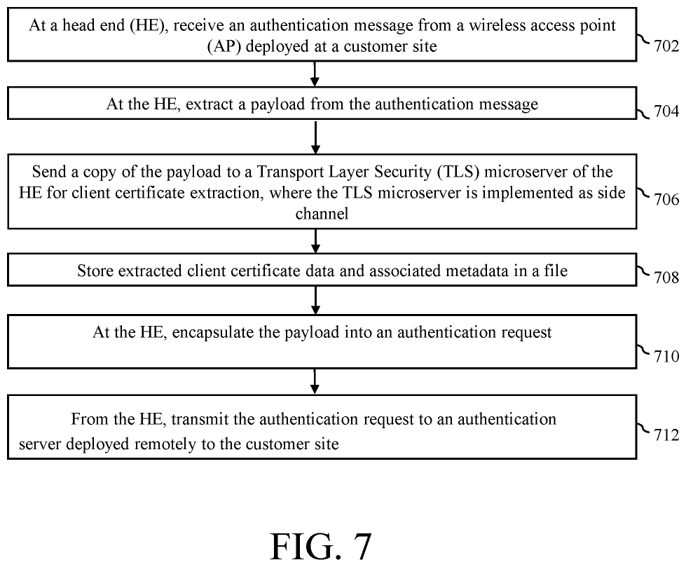

FIG. 7 is a process flow diagram of a method of communications in accordance to an embodiment of the invention. According to the method, at block 702, at an HE deployed at a customer site, an authentication message is received from a wireless access point (AP) deployed at the customer site. At block 704, at the HE, a payload is extracted from the authentication message. At block 706, a copy of the payload is sent to a Transport Layer Security (TLS) microserver of the HE for client certificate extraction, where the TLS microserver is implemented in a side signal channel. At block 708, extracted client certificate data and associated metadata is stored in a file. At block 710, at the HE, the payload is encapsulated into an authentication request. At block 712, from the HE, the authentication request is transmitted to an authentication server deployed remotely to the customer site. The HE may be similar to, the same as, or a component of the network devices 104-1, . . . , 104-N depicted in FIG. 1, the network device 204 depicted in FIG. 2, the HE 354 depicted in FIG. 3 and/or the HE 554 depicted in FIG. 5. The wireless AP may be similar to, the same as, or a component of the wireless APs 360-1, 360-2 depicted in FIG. 3 and/or the client 562 depicted in FIG. 5. The authentication server may be similar to, the same as, or a component of the authentication server 322 depicted in FIG. 3 and/or the authentication server 522 depicted in FIG. 5. The customer site may be similar to, the same as, or a component of the customer site 114 depicted in FIG. 1.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method of communications, the method comprising:
at a network device, receiving an authentication message from a client;
at the network device, extracting a payload from the authentication message; and
sending a copy of the payload to a Transport Layer Security (TLS) microserver of the network device for client certificate extraction, wherein the TLS microserver is implemented in a side signal channel.

2. The method of claim 1, further comprising creating the TLS microserver on a per-client basis using a software package.

3. The method of claim 1, further comprising discarding an output that the TLS microserver produces.

4. The method of claim 1, further comprising storing extracted client certificate data and associated metadata in a file.

5. The method of claim 4, wherein the associated metadata comprises a Medium Access Control (MAC) address of the client.

6. The method of claim 1, further comprising shutting down the TLS microserver as soon as a client certificate is extracted.

7. The method of claim 1, wherein the authentication message comprises an Extensible Authentication Protocol (EAP) message.

8. The method of claim 7, further comprising:
at the network device, encapsulating the payload into an authentication request; and
from the network device, transmitting the authentication request to an authentication server.

9. The method of claim 8, wherein the authentication request comprises a Remote Authentication Dial-In User Service (RADIUS) message.

10. The method of claim 9, further comprising:
at the network device, receiving an authentication response from the authentication server in response to the authentication request.

11. The method of claim 10, further comprising:
at the network device, generating an authentication response message based on the authentication response.

12. The method of claim 11, further comprising:
from the network device, transmitting the authentication response message to the client.

13. The method of claim 1, wherein the network device comprises a head end (HE) deployed at a customer site.

14. The method of claim 13, wherein the authentication server is deployed remotely to the customer site.

15. A device comprising:
a transceiver configured to receive an authentication message from a client; and
one or more processors configured to:
extract a payload from the authentication message; and
send a copy of the payload to a Transport Layer Security (TLS) microserver of the device for client certificate extraction, wherein the TLS microserver is implemented in a side signal channel.

16. The device of claim 15, wherein the one or more processors are further configured to create the TLS microserver on a per-client basis using a software package.

17. The device of claim 15, wherein the one or more processors are further configured to discard an output that the TLS microserver produces.

18. The device of claim 15, wherein the one or more processors are further configured to store extracted client certificate data and associated metadata in a file.

19. The device of claim 18, wherein the associated metadata comprises a Medium Access Control (MAC) address of the client.

20. A method of communications, the method comprising:
at a head end (HE) deployed at a customer site, receiving an authentication message from a wireless access point (AP) deployed at the customer site;
at the HE, extracting a payload from the authentication message;
sending a copy of the payload to a Transport Layer Security (TLS) microserver of the HE for client certificate extraction, wherein the TLS microserver is implemented in a side signal channel;
storing extracted client certificate data and associated metadata in a file;
at the HE, encapsulating the payload into an authentication request; and
from the HE, transmitting the authentication request to an authentication server deployed remotely to the customer site.
